(19) United States
(12) Patent Application Publication
(10) Pub. No.: US 2026/0297352 A1
(43) Pub. Date: Oct. 1, 2026

(54) Textile Printing Ink Jet Ink Composition And Recording Method

(71) Applicant: SEIKO EPSON CORPORATION, Tokyo (JP)

(72) Inventors: Hisashi OKAMURA, Shiojiri (JP); Nozomi UZUHASHI, Matsumoto (JP)

(21) Appl. No.: 19/578,050

(22) Filed: Mar. 25, 2026

(30) Foreign Application Priority Data
Mar. 26, 2025 (JP) 2025-051802

(51) Int. Cl. C09D 11/328; C09D 11/38; D06P 1/384; D06P 1/653; D06P 1/92; D06P 5/30

(52) U.S. Cl. CPC C09D 11/328; C09D 11/38; D06P 1/384; D06P 1/653; D06P 1/928; D06P 5/30

(57) ABSTRACT

A textile printing ink jet ink composition according to an embodiment of the present disclosure is an aqueous composition including: (A) a water-soluble coloring material having one or more functional groups selected from a vinyl sulfone group (—SO₂—CH═CH₂) and a sulfatoethyl sulfonyl group (—SO₂—CH₂CH₂—O—SO₃X, where X is selected from H, Na, K, and NH₄); and (B) a multimer having a molecular structure in which two or more moieties in which the one or more functional groups selected from the vinyl sulfone group and the sulfatoethyl sulfonyl group are removed from the molecular structure of the water-soluble coloring material (A) are bonded via —SO₂—CH₂CH₂—O—CH₂CH₂—SO₂— (provided that the multimer (B) is excluded from the water-soluble coloring material (A)).

The present application is based on, and claims priority from JP Application Serial Number 2025-051802, filed Mar. 26, 2025, the disclosure of which is hereby incorporated by reference herein in its entirety.

### BACKGROUND

### 1. Technical Field

The present disclosure relates to a textile printing ink jet ink composition and a recording method.

### 2. Related Art

An ink jet method is applied to not only recording of an image on paper or the like but also textile printing on a fabric. Among them, various studies have been made in order to improve color developability and washing fastness of an image printed on a fabric.

For example, JP-A-2018-104589 discloses an ink jet textile printing ink containing a sulfatoethyl sulfone (SES) form of a vinyl sulfone type reactive dye and urea.

However, while an ink using a dye having a sulfatoethyl sulfonyl group is excellent in color developability, the dye having a sulfatoethyl sulfonyl group has high solubility in water, and thus tends to be poor in washing fastness. Therefore, there is a problem in achieving both color developability and washing fastness.

### SUMMARY

An aspect of a textile printing ink jet ink composition according to the present disclosure is an aqueous composition including: (A) a water-soluble coloring material having one or more functional groups selected from a vinyl sulfone group (—SO₂—CH═CH₂) and a sulfatoethyl sulfonyl group (—SO₂—CH₂CH₂—O—SO₃X, where X is selected from H, Na, K, and NH₄); and (B) a multimer having a molecular structure in which two or more moieties in which the one or more functional groups selected from the vinyl sulfone group and the sulfatoethyl sulfonyl group are removed from the molecular structure of the water-soluble coloring material (A) are bonded via —SO₂—CH₂CH₂—O—CH₂CH₂—SO₂— (provided that the multimer (B) is excluded from the water-soluble coloring material (A)).

An aspect of a recording method according to the present disclosure includes ejecting the textile printing ink jet ink composition of the aspect described above from an ink jet head and attaching the textile printing ink jet ink composition to a fabric.

### BRIEF DESCRIPTION OF THE DRAWINGS

FIG. 1 is a flowchart of a recording method according to an embodiment.

FIG. 2 is a perspective view of a serial printer used in the recording method according to the embodiment.

FIG. 3 is a schematic side view of a line printer used in the recording method according to the embodiment.

FIG. 4 is Table 1 showing compositions and evaluation results of a textile printing ink jet ink composition according to each example.

### DESCRIPTION OF EMBODIMENTS

Embodiments of the present disclosure will be described below. The embodiments described below describe examples of the present disclosure. The present disclosure is not limited to the following embodiments, and includes various modifications implemented within a range not changing the gist of the present disclosure. It is noted that not all of the configurations described below are essential configurations of the present disclosure.

In the present specification, a numerical range indicated by using “to” means a range including numerical values described before and after “to” as a lower limit value and an upper limit value.

In the present specification, “(meth)acrylic” means acrylic or methacrylic, and “(meth)acrylate” means acrylate or methacrylate.

### 1. TEXTILE PRINTING INK JET INK COMPOSITION

A textile printing ink jet ink composition according to an embodiment of the present disclosure is an aqueous composition including: (A) a water-soluble coloring material having one or more functional groups selected from a vinyl sulfone group (—SO₂—CH═CH₂) and a sulfatoethyl sulfonyl group (—SO₂—CH₂CH₂—O—SO₃X, where X is selected from H, Na, K, and NH₄); and (B) a multimer having a molecular structure in which two or more moieties in which the one or more functional groups selected from the vinyl sulfone group and the sulfatoethyl sulfonyl group are removed from the molecular structure of the water-soluble coloring material (A) are bonded via —SO₂—CH₂CH₂—O—CH₂CH₂—SO₂— (provided that the multimer (B) is excluded from the water-soluble coloring material (A)).

A dye having a sulfatoethyl sulfonyl group (hereinafter, also referred to as a “SES-type dye”) has been heretofore used because good ink color developability tends to be obtained.

It has now been found that since the SES-type dye has high solubility in water, the dye is redissolved in water when a textile printed article using the SES-type dye is washed, and washing fastness may be poor.

As a result of intensive studies by the present inventors, it has been found that when both an unbound dye monomer and a multimer are contained, redissolution of the dye in water can be suppressed and washing fastness can be improved while maintaining good color developability.

Each component included in the textile printing ink jet ink composition (hereinafter, also referred to as an “ink composition”) according to the embodiment will be described.

### 1. 1 Water-Soluble Coloring Material (A)

The textile printing ink jet ink composition according to the present embodiment includes (A) a water-soluble coloring material having one or more functional groups selected from a vinyl sulfone group (—SO₂—CH═CH₂) and a sulfatoethyl sulfonyl group (—SO₂—CH₂CH₂—O—SO₃X, where X is selected from H, Na, K, and NH₄) (provided that the multimer (B) described below is excluded from the water-soluble coloring material (A)).

The SES-type dye from which the water-soluble coloring material (A) is derived reacts, for example, under conditions such as in the presence of an alkali, as shown in Formula (1).

D-(SO₂—CH₂CH₂—O—SO₃X)ₙ (SES form)→(CH₂═CH—SO₂)ₘ-D-(SO₂—CH₂CH₂—O—SO₃X)ₙ₋ₘ (VS form)+m·HO—SO₃X (1)

In Formula (1), D represents a dye base having an azo (—N═N—) bond, and X independently represents H, a monovalent metal cation or NH₄, n represents an integer of 1 or more, m represents an integer of 0 or more, and n≥m.

Examples of the dye base D having an azo bond include a benzene-azo-based dye base, a naphthalene-azo-based dye base, a pyridone-azo-based dye base, a pyrazolone-azo-based dye base, and a barbituric acid-azo-based dye base. D is preferably a dye base selected from a benzene-azo-based dye base, a naphthalene-azo-based dye base, a pyridone-azo-based dye base, a pyrazolone-azo-based dye base, and a barbituric acid-azo-based dye base.

X in the sulfatoethyl sulfonyl group (—SO₂—CH₂CH₂—O—SO₃X) is preferably selected from H, Na, K, and NH₄.

The water-soluble coloring material (A) preferably has two or more of the one or more functional groups selected from a vinyl sulfone group and a sulfatoethyl sulfonyl group. In other words, in Formula (1), n is preferably 2 or more. Such a water-soluble coloring material (A) tends to more actively react with a fabric and to be more excellent in color developability.

The water-soluble coloring material (A) may be used alone or in combination of two or more kinds thereof. Specifically, the water-soluble coloring material (A) may be an SES form or a VS form in Formula (1), or a mixture thereof.

Examples of a coloring material from which the water-soluble coloring material (A) is derived include C.I. Reactive Black 5, 14, 31; C.I. Reactive Orange 16, 78, 131, 107; C.I. Reactive Red 23, 35, 106, 180, 195, 278; C.I. Reactive Blue 19, 21, 38, 229; C.I. Reactive Yellow 15, 37, 42; C. I. Reactive Brown 18; and C.I. Reactive Violet 5.

Among these, the water-soluble coloring material (A) is preferably derived from one or more coloring materials selected from C.I. Reactive Black 5, C. I. Reactive Orange 16, C.I. Reactive Orange 131, C.I. Reactive Red 278, C.I. Reactive Red 195, and C. I. Reactive Blue 19. In other words, the water-soluble coloring material (A) preferably has a molecular structure having one or more kinds of the dye base D selected from these coloring materials. Such a water-soluble coloring material (A) tends to be more excellent in color developability.

C.I. Reactive Black 5 (see the following formula, where X independently represents H, a monovalent metal cation, or NH₄, is preferably selected from H, Na, K, and NH₄, and is more preferably Na.)

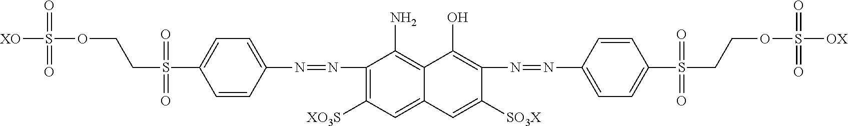

C. I. Reactive Orange 16 (see the following formula, where X independently represents H, a monovalent metal cation, or NH₄, is preferably selected from H, Na, K, and NH₄, and is more preferably Na.)

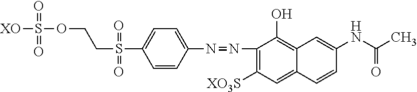

C.I. Reactive Orange 131 (see the following formula, where X independently represents H, a monovalent metal cation, or NH₄, is preferably selected from H, Na, K, and NH₄, and is more preferably Na.)

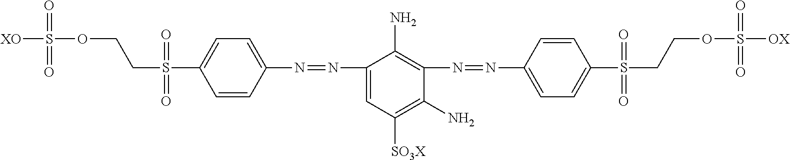

C.I. Reactive Red 278 (see the following formula, where X independently represents H, a monovalent metal cation, or NH₄, is preferably selected from H, Na, K, and NH₄, and is more preferably Na.)

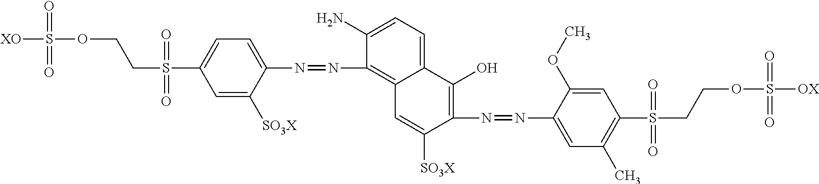

C.I. Reactive Red 195 (see the following formula, where X independently represents H, a monovalent metal cation, or NH₄, is preferably selected from H, Na, K, and NH₄, and is more preferably Na.)

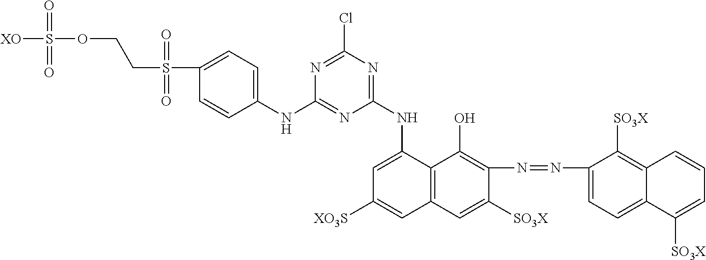

C.I. Reactive Blue 19 (see the following formula, where X independently represents H, a monovalent metal cation, or NH₄, is preferably selected from H, Na, K, and NH₄, and is more preferably Na.)

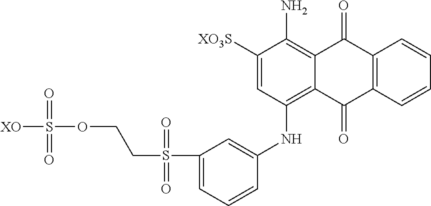

The content of the water-soluble coloring material (A) is preferably 3% by mass or more, more preferably 5% by mass or more, even more preferably 8% by mass or more, particularly preferably 108 by mass or more, and more particularly preferably 12% by mass or more with respect to the total amount of the ink composition, from the viewpoint of more excellent color developability.

In addition, the content of the water-soluble coloring material (A) is preferably 30% by mass or less, more preferably 25% by mass or less, even more preferably 22% by mass or less, particularly preferably 20% by mass or less, and more particularly preferably 18% by mass or less with respect to the total amount of the ink composition, from the viewpoint of more excellent washing fastness.

### 1. 2 Multimer (B)

The textile printing ink jet ink composition according to the present embodiment contains a multimer (B) having a molecular structure in which two or more moieties in which the one or more functional groups selected from a vinyl sulfone group and a sulfatoethyl sulfonyl group are removed from the molecular structure of the water-soluble coloring material (A) are bonded via —SO₂—CH₂CH₂—O—CH₂CH₂—SO₂—.

The multimer (B) has a lower solubility in water than the water-soluble coloring material (A) and is less likely to be redissolved during washing, and thus is more excellent in washing fastness. Therefore, by containing both the water-soluble coloring material (A) and the multimer (B), it is possible to reduce redissolution of the dye in water to improve washing fastness while maintaining good color developability.

The vinyl sulfone form (VS form) in Formula (1) undergoes a hydrolysis reaction, for example, as shown in Formula (2) to produce a hydroxyethyl sulfone form (HES form).

(CH₂═CH—SO₂)ₘ-D-(SO₂—CH₂CH₂—O—SO₃X)ₙ₋ₘ (VS form)+m·H₂O→(HO—CH₂CH₂—SO₂)ₘ-D-(SO₂—CH₂CH₂—O—SO₃X)ₙ₋ₘ (HES form) (2)

In Formula (2), D, X, n, and m are the same as those in Formula (1).

The VS form and the HES form undergo a condensation reaction, and structures of the dye base D are bonded to each other through —SO₂—CH₂CH₂—O—CH₂CH₂—SO₂—. That is, the multimer (B) has a molecular structure in which two or more structures of the dye base D are bonded to each other through —SO₂—CH₂CH₂—O—CH₂CH₂—SO₂—.

The multimer (B) preferably has a moiety in which the one or more functional groups selected from a vinyl sulfone group and a sulfatoethyl sulfonyl group are removed from the molecular structure of one or more coloring materials selected from C.I. Reactive Black 5, C. I. Reactive Orange 16, C.I. Reactive Orange 131, C.I. Reactive Red 278, C.I. Reactive Red 195, and C.I. Reactive Blue 19. In other words, the multimer (B) preferably has a molecular structure having one or more kinds of the dye base D selected from these coloring materials. Such a multimer (B) tends to be more excellent in color developability.

The multimer (B) preferably has a molecular structure in which three or more moieties in which the one or more functional groups selected from a vinyl sulfone group and a sulfatoethyl sulfonyl group are removed from the molecular structure of the water-soluble coloring material (A) are bonded via —SO₂—CH₂CH₂—O—CH₂CH₂—SO₂—. In other words, the multimer (B) preferably has a molecular structure in which three or more structures of the dye base D are bonded via —SO₂—CH₂CH₂—O—CH₂CH₂—SO₂—. Such a multimer (B) is less likely to be redissolved during washing, and thus tends to be more excellent in washing fastness.

The content ratio of the multimer (B) to the water-soluble coloring material (A) (mass ratio (mass %) of multimer (B) to total amount of ink composition/mass ratio (mass %) of water-soluble coloring material (A) to total amount of ink composition; hereinafter, also referred to as “content ratio (B)/(A)”) is preferably 1.0 or less, more preferably 0.8 or less, even more preferably 0.6 or less, particularly preferably 0.5 or less, more particularly preferably 0.3 or less, even more preferably 0.2 or less, and especially preferably 0.15 or less. When the content ratio (B)/(A) is within the above ranges, color developability tends to be more excellent. In the multimer (B), the adjacent coloring material molecules are oriented in opposite directions (chain arrangement), the dipole moments thereof cancel each other, and the absorbance may be decreased by heat. Since this influence increases as the amount of the multimer (B) increases, the content ratio (B)/(a) is preferably within any of the above ranges.

The content ratio (B)/(A) is preferably 0.001 or more, more preferably 0.004 or more, still more preferably 0.010 or more, yet still more preferably 0.030 or more, particularly preferably 0.050 or more, more particularly preferably 0.080 or more, and especially preferably 0.100 or more. When the content ratio (B)/(A) is within the above ranges, the coloring material is less likely to be redissolved during washing, and washing fastness tends to be more excellent.

In particular, the content ratio (B)/(A) is preferably 0.004 or more and 0.5 or less. When the content ratio (B)/(A) is within the above ranges, color developability tends to be more excellent, and washing fastness tends to be more excellent.

The content of the multimer (B) is preferably 0.01% by mass or more, more preferably 0.10% by mass or more, even more preferably 0.50% by mass or more, particularly preferably 0.70% by mass or more, more particularly preferably 1.00% by mass or more, and especially preferably 1.20% by mass or more with respect to the total amount of the ink composition, from the viewpoint of more excellent washing fastness.

In addition, the content of the multimer (B) is preferably 15% by mass or less, more preferably 10% by mass or less, even more preferably 78 by mass or less, particularly preferably 58 by mass or less, more particularly preferably 3% by mass or less, and especially preferably 2% by mass or less with respect to the total amount of the ink composition, from the viewpoint of more excellent color developability.

### 1. 3 pH Adjuster

The textile printing ink jet ink composition according to the embodiment may contain a pH adjuster.

The pH adjuster is not particularly limited, and examples thereof include an appropriate combination of an acid, a base, a weak acid, and a weak base. Examples of the acid and base used for such a combination include an inorganic acid such as sulfuric acid, hydrochloric acid, and nitric acid; an inorganic base such as lithium hydroxide; sodium hydroxide, potassium hydroxide, potassium dihydrogen phosphate, disodium hydrogen phosphate, potassium carbonate, sodium carbonate, and sodium hydrogen carbonate, and ammonia; an organic base such as triethanolamine, diethanolamine, monoethanolamine, tripropanolamine, triisopropanolamine, diisopropanolamine, and trishydroxymethylaminomethane (THAM); and an organic acid such as acetic acid, adipic acid, citric acid, succinic acid, lactic acid, malonic acid, N, N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyliminobisacetic acid (ADA), piperazine-1,4-bis(2-ethanesulfonic acid) (PIPES), N-(2-acetamido)-2-aminoethanesulfonic acid (ACES), cholamine hydrochloride, and N-tris(hydroxymethyl)methyl-2-aminoethanesulfonic acid (TES). Good's buffers such as acetamidoglycine. tricine, glycinamide, and bicine, a phosphate buffer, a citrate buffer, a tris buffer, and the like may also be used.

Among these, it is preferable to contain any one or more pH adjusters selected from acetic acid, citric acid, lactic acid, malonic acid, and succinic acid. In a case where such a pH adjuster is contained, the pH of the ink composition is easily set to be in a preferable range, and thus there is a tendency that more favorable color developability is obtained.

The pH of the textile printing ink jet ink composition according to the embodiment is preferably 1.5 or more, more preferably 2 or more, even more preferably 3 or more, and particularly preferably 3.5 or more. In addition, the pH of the textile printing ink jet ink composition is preferably 7 or less, more preferably 6 or less, even more preferably 5 or less, and particularly preferably 4.5 or less.

In particular, the pH of the ink composition is preferably 3 or more and 6 or less from the viewpoint of a tendency to be more excellent in color developability.

The content of the pH adjuster is not particularly limited, but is preferably 0.1% by mass to 5% by mass, more preferably 0.5% by mass to 3% by mass, still more preferably 0.7% by mass to 2% by mass, and particularly preferably 0.8% by mass to 1.5% by mass, with respect to the total amount of the ink composition.

### 1. 4 Organic Solvent

The textile printing ink jet ink composition according to the present embodiment may contain an organic solvent. The organic solvent is preferably a water-soluble organic solvent. The term “water-soluble” means that the water solubility at 20° C. is more than 10 g/100 g of water.

Examples of the organic solvent include esters, alkylene glycol ethers, cyclic esters, amides, alcohols, polyhydric alcohols, and the like.

Examples of the esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, propylene glycol acetate propionate, propylene glycol acetate butyrate, dipropylene glycol acetate butyrate, and dipropylene glycol acetate propionate.

Examples of the alkylene glycol ethers include alkylene glycol monoalkyl ethers and alkylene glycol dialkyl ethers. Specific examples include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of the cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; and compounds in which a hydrogen atom of a methylene group adjacent to a carbonyl group thereof is substituted with an alkyl group having 1 to 4 carbon atoms.

Examples of the amides include cyclic amides and acyclic amides.

Examples of the cyclic amides include lactams (lactam-based compounds). Examples of the lactams include pyrrolidones such as 1-(2-hydroxyethyl)-2-pyrrolidone (HEP), 2-pyrrolidone, 1-methyl-2-pyrrolidone, 1-ethyl-2-pyrrolidone, 1-propyl-2-pyrrolidone, and 1-butyl-2-pyrrolidone; and lactams other than those having a 5-membered ring lactam structure, such as ε-caprolactam, N-methyl-ε-caprolactam, β-propiolactam, and ω-heptalactam.

Examples of the acyclic amides include formamides such as N, N-dimethylformamide; and alkoxyalkylamides.

Examples of the alkoxyalkylamides include 3-methoxy-N, N-dimethylpropionamide, 3-methoxy-N, N-diethylpropionamide, 3-methoxy-N, N-methylethylpropionamide, 3-ethoxy-N, N-dimethylpropionamide, 3-ethoxy-N, N-diethylpropionamide, 3-ethoxy-N, N-methylethylpropionamide, 3-n-butoxy-N, N-dimethylpropionamide, 3-n-butoxy-N, N-diethylpropionamide, 3-n-butoxy-N, N-methylethylpropionamide, 3-n-propoxy-N, N-dimethylpropionamide, 3-n-propoxy-N, N-diethylpropionamide, 3-n-propoxy-N, N-methylethylpropionamide, 3-iso-propoxy-N, N-dimethylpropionamide, 3-iso-propoxy-N, N-diethylpropionamide, 3-iso-propoxy-N, N-methylethylpropionamide, 3-tert-butoxy-N, N-dimethylpropionamide, 3-tert-butoxy-N, N-diethylpropionamide, 3-tert-butoxy-N, N-methylethylpropionamide, and N, N-dimethylisobutyramide.

Examples of the alcohols include a compound in which one hydrogen atom of an alkane is substituted with a hydroxy group. The alkane has preferably 10 or less carbon atoms, more preferably 6 or less carbon atoms, and even more preferably 3 or less carbon atoms. The number of carbon atoms of the alkane is 1 or more, and is preferably 2 or more. The alkane may be a linear type or a branched type. Examples of the alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, and phenoxy propanol.

Polyhydric alcohols each have two or more hydroxy groups in a molecule. The polyhydric alcohols can be classified into, for example, alkanediols and polyols. Examples of the alkanediols include a compound in which an alkane is substituted with two hydroxy groups. Examples of the alkanediols include 1,2-alkanediol, that is a general term for compounds in which hydrogen atoms at the 1-position and 2-position of an alkane are substituted with hydroxy groups, and other alkanediols other than the 1,2-alkanediol.

Examples of the 1,2-alkanediol include ethylene glycol, 1,2-propanediol (propylene glycol), 1,2-butanediol (1,2BD), 1,2-pentanediol (1,2PD), 1,2-hexanediol (1,2HD), 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, and 2-methyl-2-propyl-1,3-propanediol.

Examples of the polyols include a condensate in which two or more alkanediol molecules are intermolecularly condensed through hydroxy groups, and a compound having three or more hydroxy groups.

Examples of the condensate in which two or more alkanediol molecules are intermolecularly condensed through hydroxy groups include dialkylene glycols such as diethylene glycol and dipropylene glycol, and trialkylene glycols such as triethylene glycol and tripropylene glycol.

The compound having three or more hydroxy groups is a compound having an alkane or polyether structure as a skeleton and having three or more hydroxy groups. Examples of the compound having three or more hydroxy groups include glycerin, trimethylolethane, trimethylolpropane, 1,2,5-hexanetriol, 1,2,6-hexanetriol, pentaerythritol, and polyoxypropylenetriol.

The organic solvent may be used alone or in combination of two or more kinds thereof.

Among these organic solvents, a lactam-based compound is preferably contained, a pyrrolidone is more preferably contained, and 1-(2-hydroxyethyl)-2-pyrrolidone (HEP) is still more preferably contained.

By containing the lactam-based compound, the solubility of the dye is further improved, and color developability, washing fastness, and ink ejection reliability tend to be more excellent. In addition, when a pyrrolidone is contained, the permeability is further improved, and color developability, washing fastness, and ink ejection reliability tend to be more excellent. In particular, when HEP (1-(2-hydroxyethyl)-2-pyrrolidone) is contained, the permeability is further improved, and color developability, washing fastness, and ink ejection reliability tend to be more excellent.

The content of the organic solvent is not particularly limited, but is preferably 0.1% by mass to 20% by mass, more preferably 0.5% by mass to 15% by mass, even more preferably 18 by mass to 12% by mass, particularly preferably 2% by mass to 10% by mass, and more particularly preferably 3% by mass to 8% by mass with respect to the total amount of the ink composition.

In particular, it is also preferable that the content of the lactam-based compound (preferably a pyrrolidone, and more preferably HEP) is within the ranges described above.

### 1. 5 Water

The textile printing ink jet ink composition according to the present embodiment is water-based and contains water. Examples of water include pure water such as ion-exchanged water, ultrafiltration water, reverse osmosis water, and distilled water; and ultrapure water, from which ionic impurities are removed as much as possible. In addition, water sterilized by ultraviolet irradiation, addition of hydrogen peroxide, or the like is preferable because generation of mold or bacteria can be suppressed in a case where the ink composition is stored for a long period of time.

The content of water is preferably 30% by mass or more, more preferably 50% by mass or more, still more preferably 60% by mass or more, and particularly preferably 70% by mass or more with respect to the total amount of the ink composition. The upper limit of the content of water is not particularly limited, but is, for example, preferably less than 100% by mass, more preferably 95% by mass or less, still more preferably 90% by mass or less, and particularly preferably 85% by mass or less with respect to the total amount of the ink composition.

In the present embodiment, the term “water-based” means that the content of water is 30% by mass or more with respect to the total amount of the ink composition.

### 1. 6 Surfactant

The textile printing ink jet ink composition according to the present embodiment may contain a surfactant. Examples of the surfactant include an acetylene glycol-based surfactant, a fluorine-based surfactant, and a silicone-based surfactant. The surfactant may be used alone or in combination of two or more kinds thereof.

Examples of the acetylene glycol-based surfactant include 2,4,7,9-tetramethyl-5-decyne-4,7-diol and an alkylene oxide adduct thereof, and 2,4-dimethyl-5-decyne-4-ol and an alkylene oxide adduct thereof.

As the acetylene glycol-based surfactant, a commercially available product can also be used. Examples of the commercially available product include OLFINE (registered trademark) 104 series (trade name) and E series (trade name) manufactured by Nissin Chemical Industry Co., Ltd.; and SURFYNOL (registered trademark) series (trade name) manufactured by Air Products and Chemicals, Inc.

Examples of the fluorine-based surfactant include a perfluoroalkyl sulfonic acid salt, a perfluoroalkyl carboxylic acid salt, a perfluoroalkyl phosphoric acid ester, a perfluoroalkyl ethylene oxide adduct, a perfluoroalkyl betaine, and a perfluoroalkylamine oxide compound.

As the fluorine-based surfactant, a commercially available product can also be used. Examples of the commercially available product include S-144 (trade name) and S-145 (trade name) manufactured by AGC Inc.

Examples of the silicone-based surfactant include a polysiloxane-based compound and a polyether-modified organosiloxane.

As the silicone-based surfactant, a commercially available product can also be used. Examples of the commercially available product include 306, 307, 333, 341, 345, 346, 347, 348, and 349 (all trade names) of BYK (registered trademark) series manufactured by BYK Japan K.K.

The content of the surfactant is not particularly limited, but is preferably 0.01% by mass to 5.0% by mass, more preferably 0.03% by mass to 2.0% by mass, even more preferably 0.05% by mass to 1.0% by mass, particularly preferably 0.07% by mass to 0.5% by mass, and more particularly preferably 0.08% by mass to 0.2% by mass with respect to the total amount of the ink composition.

### 1. 7 Preservative

The textile printing ink jet ink composition according to the present embodiment may contain a preservative. The preservative also functions as a fungicide. The preservative may be used alone or in combination of two or more kinds thereof.

Examples of the preservative include sodium benzoate, sodium pentachlorophenol, sodium 2-pyridinethiol-1-oxide, sodium sorbate, sodium dehydroacetate, 1,2-dibenzoisothiazolin-3-one, and 4-chloro-3-methylphenol (e.g., PREVENTOL CMK available from Bayer AG). As the preservative, a commercially available product can also be used. Examples of the commercially available product include CRL, BND, GXL, XL-2, and TN of Proxel (registered trademark) series (all trade names, Lonza K.K.); and PREVENTOL (registered trademark) CMK (Bayer AG).

The content of the preservative is not particularly limited, but is preferably 0.001% by mass to 5.0% by mass, more preferably 0.005% by mass to 2.0% by mass, even more preferably 0.01% by mass to 1.0% by mass, particularly preferably 0.01% by mass to 0.50% by mass, and more particularly preferably 0.01% by mass to 0.10% by mass with respect to the total amount of the ink composition.

### 1. 8 Other Components

The textile printing ink jet ink composition according to the present embodiment may contain various additives which can be generally used in the ink composition, such as a dissolution aid, a viscosity modifier, an antioxidant, an ultraviolet absorber, an oxygen absorber, a rust inhibitor, a corrosion inhibitor, and a chelating agent. One kind of the additives may be used alone, or two or more kinds thereof may be used in combination.

The content of such additives is not particularly limited, but for example, is preferably 0.01% by mass to 10.0% by mass, more preferably 0.03% by mass to 5.0% by mass, and even more preferably 0.1% by mass to 3.0% by mass with respect to the total amount of the ink composition.

In addition, the textile printing ink jet ink composition according to the present embodiment may contain a urea compound, but it is preferable that urea compounds be not contained. The urea compound has a function as a moisturizing agent, and when the urea compound is contained, ejection reliability of the ink tends to be more excellent. On the other hand, according to the textile printing ink jet ink composition of the present embodiment, even in a case where no urea compound is contained or the urea compound is contained in a small amount, ejection reliability of the ink tends to be excellent.

Examples of the urea compound includes urea, ethylene urea, tetramethylurea, and thiourea.

The content of the urea compound is preferably less than 2% by mass, more preferably 1.5% by mass or less, even more preferably 1.0% by mass or less, still more preferably 0.5% by mass or less, and particularly preferably 0.1% by mass or less with respect to the total amount of the ink composition. The lower limit of the content is 0% by mass (no urea compound is contained).

### 1. 9 Method for Producing Ink Composition

The ink composition can be prepared, for example, by mixing the components described above in an arbitrary order, and removing impurities, foreign substances, and the like by performing filtration or the like as necessary. As a method of mixing the components, a method of sequentially adding the components to a container provided with a stirring device such as a mechanical stirrer or a magnetic stirrer, and stirring and mixing the components is used. Examples of the filtration method include centrifugal filtration and filter filtration.

### 2. RECORDING METHOD

The recording method according to an embodiment of the present disclosure includes ejecting the above-described textile printing ink jet ink composition from an ink jet head and attaching the textile printing ink jet ink composition to a fabric.

According to the recording method of the present embodiment, since the above-described textile printing ink jet ink composition is used, both color developability and washing fastness can be improved.

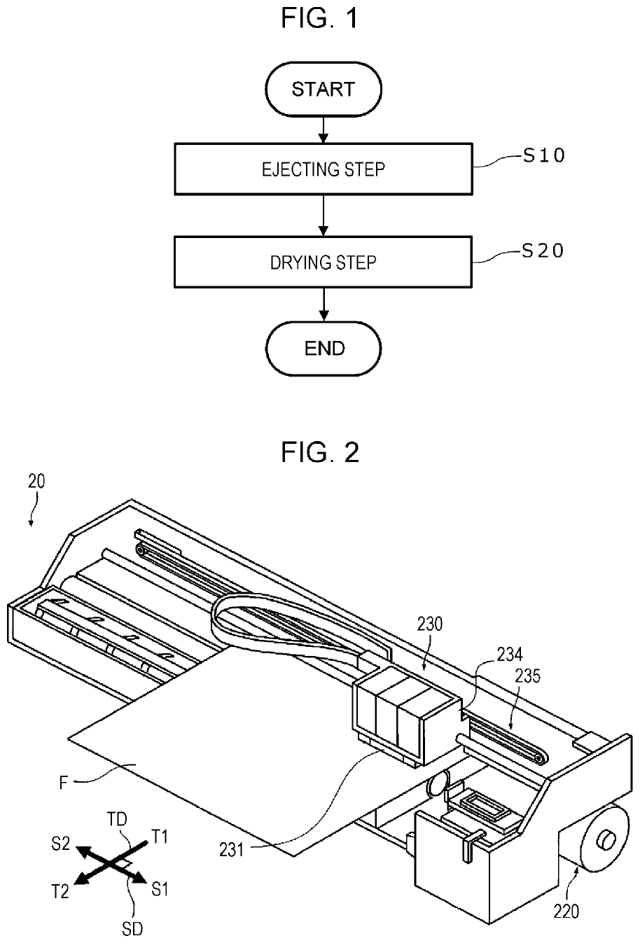

FIG. 1 is a flowchart of a recording method according to an embodiment. As shown in FIG. 1, the recording method according to the present embodiment includes an ejecting step (S10) of ejecting the above-described textile printing ink jet ink composition from an ink jet head and attaching the textile printing ink jet ink composition to a fabric. In the present embodiment, an example in which a drying step (S20) of drying the fabric is further included after S10 will be described.

### 2. 1 Ejecting Step (S10)

The recording method according to the present embodiment includes an ejecting step of ejecting the above-described textile printing ink jet ink composition from an ink jet head and attaching the textile printing ink jet ink composition to a fabric.

Since the textile printing ink jet ink composition is as described above, the description thereof will be omitted.

The amount of the ink composition applied to the fabric per unit area is preferably from 10 g/m² to 40 g/m², more preferably from 15 g/m² to 35 g/m², and still more preferably from 20 g/m² to 30 g/m².

Examples of the material of the fabric include natural fibers such as cotton, hemp (linen), wool, and silk; regenerated fibers such as rayon; synthetic fibers such as polypropylene, polyester, acetate, triacetate, polyamide, and polyurethane; and biodegradable fibers such as polylactic acid, and mixed fibers thereof may be used.

Among these, the material of the fabric preferably includes one or more materials selected from cotton, wool, and silk. When these materials are contained, color developability may be more excellent.

Examples of the form of the fabric include cloth, clothes, and other accessories. The cloth includes a woven fabric, a knitted fabric, and a nonwoven fabric. Clothes and other accessories include a T-shirt, a handkerchief, a scarf, a towel, a carrier bag, a cloth bag, a curtain, a sheet, a bedspread, and furniture items such as wallpaper after sewing as well as cloth before and after cutting as a component before sewing. Examples of these forms include a long roll-shaped form, a form cut in a predetermined size, and a form having a shape of a product.

### 2. 2 Drying Step (S20)

The recording method according to the present embodiment may include a drying step of drying the fabric to which the above-described textile printing ink jet ink composition is attached after S10. By including such a drying step, washing fastness tends to be further improved.

The drying method in the drying step is not particularly limited, and examples thereof include a heat press, a belt conveyor oven, an atmospheric pressure steam method, a high-pressure steam method, a thermofix method, and blowing. The heat source for drying is not particularly limited, and, for example, an infrared lamp or the like can be used.

The drying temperature is not particularly limited, and may be 80° C. or more and 250° C. or less, 90° C. or more and 200° C. or less, 95° C. or more and 150° C. or less, or 100° C. or more and 120° C. or less. Here, the drying temperature in the drying step refers to the surface temperature of an image or the like formed on the fabric.

The time for drying is not particularly limited, but is, for example, preferably 10 seconds or more and 60 minutes or less, more preferably 1 minute or more and 50 minutes or less, still more preferably 10 minutes or more and 40 minutes or less, and particularly preferably 20 minutes or more and 35 minutes or less.

The drying step may be performed while applying pressure using a heat press or the like. The pressure to be applied is not particularly limited, but is preferably 1 N/cm² to 10 N/cm², more preferably 1 N/cm² to 8 N/cm², and still more preferably 1 N/cm² to 5 N/cm².

### 2. 3 Other Steps

The recording method according to the present embodiment may include a step of rinsing with water the fabric on which recording is performed, a step of performing heating and drying again, and the like. In rinsing with water, components such as the ink not fixed on the fabric may be washed away using a hot soap liquid or the like as soaping treatment as needed.

### 2. 4 Ink Jet Recording Apparatus

An example of an ink jet recording apparatus suitable for the recording method according to an exemplary embodiment will be described.

As an example of the ink jet recording apparatus, FIG. 2 illustrates a perspective view of a serial printer. As illustrated in FIG. 2, a serial printer 20 is provided with a transport portion 220 and a recording portion 230. The transport portion 220 transports a recording medium F fed to the serial printer to the recording portion 230, and the recording medium after recording is discharged outside the serial printer. Specifically, the transport portion 220 includes each feeding roller and transports the fed recording medium F in a transport direction TD.

In addition, the recording portion 230 is provided with a carriage 234 on which an ink jet head 231 having a nozzle which ejects the above-described textile printing ink jet ink composition onto the recording medium F fed from the transport portion 220 is mounted, and a carriage movement mechanism 235 which moves the carriage 234 in a scanning direction SD of the recording medium F.

When the serial printer is used, a head having a length less than the width of the recording medium is provided as the ink jet head 231, and recording is performed while the head moves in the scanning direction SD intersecting with the transport direction TD of the recording medium F. In addition, in the serial printer, the head 231 is mounted on the carriage 234 which moves in a predetermined direction, and the ink composition is ejected onto a recording medium by the head moving along with the movement of the carriage. The recording medium may be transported between scanning passes.

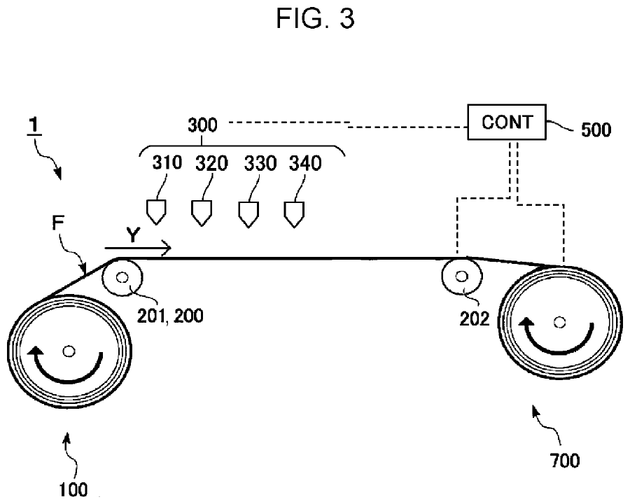

In addition, the ink jet recording device is not limited to the above-described serial type printer, and may be a line type printer. FIG. 3 illustrates a schematic side view of a line printer as another example of the ink jet recording apparatus. As illustrated in FIG. 3, a line printer 1 includes a feeding portion 100, a transport mechanism 200 for transporting a recording medium in a transport direction, a line head 300 that ejects ink to attach the ink to the recording medium, a control portion 500, and a discharge portion 700.

The transport mechanism is a mechanism for transporting the recording medium in the transport direction. In FIG. 3, a roll-shaped recording medium F is fed from the feeding portion 100 to the transport mechanism 200, and the transport mechanism 200 is configured to transport the recording medium F fed from the feeding portion 100 to the line head 300. Specifically, the transport mechanism 200 includes a first feeding roller 201 and a second feeding roller 202 and is configured to transport the fed recording medium F to the line head 300 downstream in the transport direction. As a transport method of the transport mechanism 200, a known method in the related art can be appropriately used, or one or a plurality of rollers, a belt driven by a roller, or the like may be used.

The line printer 1 includes the line head 300 having a length corresponding to the width of the recording medium F. The line head 300 may be constituted by a plurality of line heads, and in FIG. 3, the line head 300 is constituted by a first line head 310, a second line head 320, a third line head 330, and a fourth line head 340.

The line head 300 includes a cavity which accommodates a textile printing ink jet ink composition of each color, an ejection driving portion which is provided for each cavity, and a nozzle which ejects ink. A plurality of cavities, and a plurality of ejection driving portions and a plurality of nozzles provided for each cavity may be provided in one head independently of one another. The ejection driving portion can be formed using an electromechanical conversion element such as a piezoelectric element that changes the volume of the cavities by mechanical deformation, an electrothermal conversion element that emits heat to generate an air bubble in the ink and ejects the ink, and the like.

In the line printer, the heads are fixed and do not move (substantially), and the recording is performed in a single scanning pass of the ink jet heads. The line printer is more advantageous than the serial printer in terms of a high recording speed.

### 3. EXAMPLES

The present disclosure will be described in more detail with reference to examples below, but the present disclosure is not limited to these examples. Hereinafter, “%” is based on mass unless otherwise specified.

### 3. 1 Preparation of Textile Printing Ink Jet Ink Composition

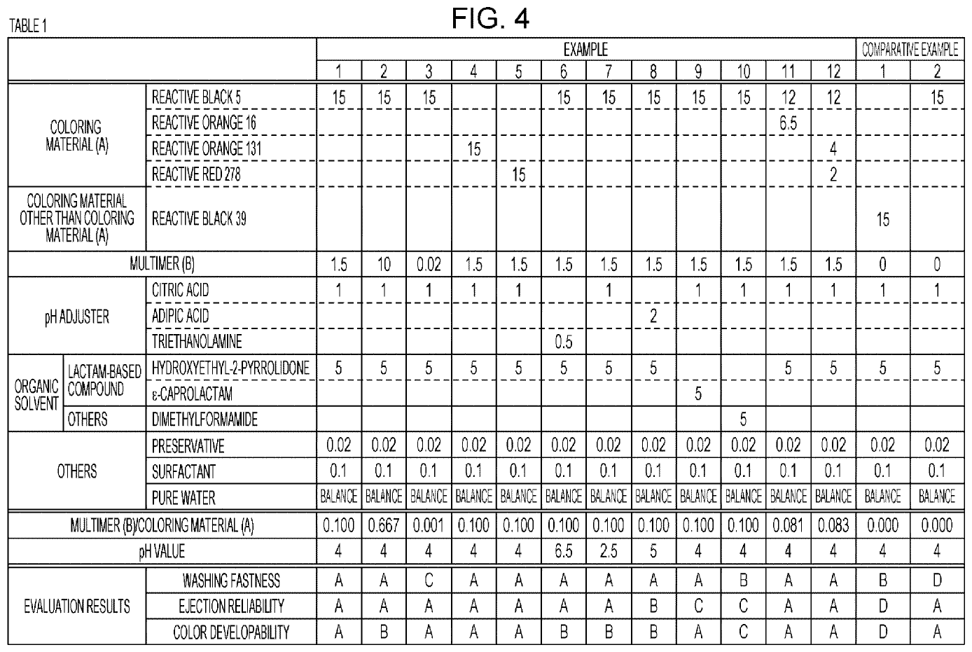

Components are put into a container so as to achieve the composition shown in Table 1 (FIG. 4), mixed and stirred for 2 hours with a magnetic stirrer, then sufficiently mixed by performing dispersing processing with a bead mill filled with zirconia beads having a diameter of 0.3 mm, then stirred for 1 hour, and then filtered using a 5 μm PTFE membrane filter to obtain a textile printing ink jet ink composition of each example.

The following gives a supplementary description for Table 1.

The coloring material (A) reacts in the ink composition as shown in Formula (1) described above, and becomes an SES form, a VS form, or a mixture thereof.

The multimer (B) has a molecular structure in which two or more structures of a dye base of the coloring material (A) in each example are bonded via —SO₂—CH₂CH₂—O—CH₂CH₂—SO₂—. The multimer (B) is synthesized by subjecting the VS form and the HES form of the coloring material (A) in each example to a condensation reaction.

The multimer (B) in each of Examples 11 and 12 has a molecular structure in which two or more structures of the dye base of at least one or more kinds of the coloring material (A) in each example are bonded via —SO₂—CH₂CH₂—O-CH₂CH₂—SO₂—.
Preservative: Proxel XL-2 (trade name, manufactured by Lonza K.K.)
Surfactants: OLFINE PD002W (trade name, manufactured by Nissin Chemical Industry Co., Ltd.)

### 3. 2 Evaluation Method

### 3. 2. 1 Washing Fastness

An ink cartridge mounted on a recording apparatus (manufactured by Seiko Epson Corporation, PX-H6000) is filled with the textile printing ink jet ink composition according to each example, and solid printing is performed on a cotton fabric at a duty of 100%. Next, a steaming treatment was performed for 30 minutes under a highly humidified condition of 102° C. using a steamer (steamer DHe type, manufactured by Mathis AG) to obtain a textile printed article according to each example, and washing fastness is measured by the method in accordance with ISO 105-C10:2006, and the washing fastness is evaluated on the basis of the following evaluation criteria. A rating of C or higher is considered to indicate good washing fastness.

### Evaluation Criteria

A: Washing fastness is grade 4 or higher.
B: Washing fastness is grade 3 or higher and less than grade 4.
C: Washing fastness is grade 2 or higher and less than grade 3.
D: Washing fastness is less than grade 2.

### 3. 2. 2 Ejection Reliability

An ink cartridge mounted on a recording apparatus (manufactured by Seiko Epson Corporation, PX-H6000) is filled with the textile printing ink jet ink composition according to each example. Then, after confirming that all nozzles normally eject without dropout, misdirection, or the like, continuous ejection is continued for 10 hours, and ejection reliability is evaluated on the basis of the following evaluation criteria. A rating of C or higher is considered to indicate good ejection reliability.

### Evaluation Criteria

A: Normal ejection from all nozzles.
B: Dropout or misdirection occurs in less than 10% of the total number of nozzles.
C: Dropout or misdirection occurs in 10% or more and less than 20% of the total number of nozzles.
D: Dropout or misdirection occur in 20% or more of the total number of nozzles.

### 3. 2. 3 Color Developability

An ink cartridge mounted on a recording apparatus (manufactured by Seiko Epson Corporation, PX-930g) is filled with the textile printing ink jet ink composition according to each example, and textile printing is performed on a cotton fabric at resolution of 720 dpi×720 dpi. The OD value of the image is measured by a colorimeter (Spectrolino, manufactured by X-RITE), and color developability is evaluated on the basis of the following evaluation criteria. The OD value is Y-OD for Example 4, M-OD for Example 5, and Bk-OD for the other examples. A rating of C or higher is considered to indicate good color developability.

### Evaluation Criteria

A: The OD value is 1.70 or more.
B: The OD value is 1.60 or more and less than 1.70.
C: The OD value is 1.55 or more and less than 1.60.
D: The OD value is less than 1.55.

### 3. 3 Evaluation Results

The evaluation results are shown in Table 1.

From the evaluation results of Table 1, the textile printing ink jet ink composition according to each example achieves both good color developability and good washing fastness, the textile printing ink jet ink composition according to each example being an aqueous composition including (A) a water-soluble coloring material having one or more functional groups selected from a vinyl sulfone group (—SO₂—CH═CH₂) and a sulfatoethyl sulfonyl group (—SO₂—CH₂CH₂—O—SO₃X, where X is selected from H, Na, K, and NH₄); and (B) a multimer having a molecular structure in which two or more moieties in which the one or more functional groups selected from the vinyl sulfone group and the sulfatoethyl sulfonyl group are removed from the molecular structure of the water-soluble coloring material (A) are bonded via —SO₂—CH₂CH₂—O—CH₂CH₂—SO₂— (provided that the multimer (B) is excluded from the water-soluble coloring material (A)).

On the other hand, the textile printing ink jet ink compositions according to Comparative Examples which do not satisfy the above-described configuration are inferior in at least one of color developability and washing fastness.

The following contents are derived from the above-described embodiments.

An aspect of the textile printing ink jet ink composition is an aqueous composition including (A) a water-soluble coloring material having one or more functional groups selected from a vinyl sulfone group (—SO₂—CH═CH₂) and a sulfatoethyl sulfonyl group (—SO₂—CH₂CH₂—O—SO₃X, where X is selected from H, Na, K, and NH₄); and (B) a multimer having a molecular structure in which two or more moieties in which the one or more functional groups selected from the vinyl sulfone group and the sulfatoethyl sulfonyl group are removed from the molecular structure of the water-soluble coloring material (A) are bonded via —SO₂—CH₂CH₂—O—CH₂CH₂—SO₂— (provided that the multimer (B) is excluded from the water-soluble coloring material (A)).

In the aspect of the textile printing ink jet ink composition, the content ratio of the multimer (B) to the water-soluble coloring material (A) (mass ratio (mass %) of the multimer (B) to the total amount of the ink composition/mass ratio (mass %) of the water-soluble coloring material (A) to total amount of ink composition) may be 0.004 or more and 0.5 or less.

In any aspect of the textile printing ink jet ink composition, the water-soluble coloring material (A) may have two or more of the one or more functional groups selected from the vinyl sulfone group and the sulfatoethyl sulfonyl group.

In any aspect of the textile printing ink jet ink composition, the multimer (B) may have a moiety in which the one or more functional groups selected from the vinyl sulfone group and the sulfatoethyl sulfonyl group are removed from the molecular structure of one or more coloring materials selected from C.I. Reactive Black 5, C.I. Reactive Orange 16, C.I. Reactive Orange 131, C.I. Reactive Red 278, C.I. Reactive Red 195, and C.I. Reactive Blue 19.

In any aspect of the textile printing ink jet ink composition, the multimer (B) may have a molecular structure in which three or more moieties in which the one or more functional groups selected from the vinyl sulfone group and the sulfatoethyl sulfonyl group are removed from the molecular structure of the water-soluble coloring material (A) are bonded via —SO₂—CH₂CH₂—O—CH₂CH₂—SO₂—.

Any aspect of the textile printing ink jet ink composition may have a pH value of 3 or more and 6 or less.

Any aspect of the textile printing ink jet ink composition may include one or more pH adjusters selected from acetic acid, citric acid, lactic acid, malonic acid, and succinic acid.

Any aspect of the textile printing ink jet ink composition may include a lactam-based compound.

In any aspect of the textile printing ink jet ink composition, the lactam-based compound may include 1-(2-hydroxyethyl)-2-pyrrolidone (HEP).

An aspect of the recording method includes ejecting the textile printing ink jet ink composition described above from an ink jet head and attaching the textile printing ink jet ink composition to a fabric.

The present disclosure is not limited to the above-described embodiments, and various modifications are possible. For example, the present disclosure includes a configuration substantially the same as the configuration described in the embodiments, for example, a configuration having the same function, method, and result, or a configuration having the same object and effect. In addition, the present disclosure includes configurations in which non-essential parts of the configuration described in the embodiments are replaced. The present disclosure also includes configurations achieving the same operation and effect or configurations that can achieve the same object as the configurations described in the embodiments. In addition, the present disclosure includes configurations in which a publicly known technology is added to the configurations described in the embodiments.

What is claimed is:

1. A textile printing ink jet ink composition comprising:
(A) a water-soluble coloring material having one or more functional groups selected from a vinyl sulfone group (—SO₂—CH═CH₂) and a sulfatoethyl sulfonyl group (—SO₂—CH₂CH₂—O—SO₃X), where X is selected from H, Na, K, and NH₄; and
(B) a multimer having a molecular structure in which two or more moieties in which the one or more functional groups selected from the vinyl sulfone group and the sulfatoethyl sulfonyl group are removed from a molecular structure of the water-soluble coloring material (A) are bonded via —SO₂—CH₂CH₂—O—CH₂CH₂—SO₂—, wherein
the textile printing ink jet ink composition is an aqueous composition, and the multimer (B) is excluded from the water-soluble coloring material (A).

2. The textile printing ink jet ink composition according to claim 1, wherein
a content ratio of the multimer (B) to the water-soluble coloring material (A), which is a ratio between a mass ratio (mass %) of the multimer (B) to a total amount of the textile printing ink jet ink composition and a mass ratio (mass %) of the water-soluble coloring material (A) to the total amount of the textile printing ink jet ink composition, is 0.004 or more and 0.5 or less.

3. The textile printing ink jet ink composition according to claim 1, wherein
the water-soluble coloring material (A) has two or more of the one or more functional groups selected from a vinyl sulfone group and a sulfatoethyl sulfonyl group.

4. The textile printing ink jet ink composition according to claim 1, wherein
the multimer (B) has a moiety in which the one or more functional groups selected from the vinyl sulfone group and the sulfatoethyl sulfonyl group are removed from a molecular structure of one or more coloring materials selected from C.I. Reactive Black 5, C.I. Reactive Orange 16, C.I. Reactive Orange 131, C.I. Reactive Red 278, C. I. Reactive Red 195, and C.I. Reactive Blue 19.

5. The textile printing ink jet ink composition according to claim 1, wherein
the multimer (B) has a molecular structure in which three or more moieties in which the one or more functional groups selected from the vinyl sulfone group and the sulfatoethyl sulfonyl group are removed from a molecular structure of the water-soluble coloring material (A) are bonded via —SO₂—CH₂CH₂—O—CH₂CH₂—SO₂—.

6. The textile printing ink jet ink composition according to claim 1, having a pH value of 3 or more and 6 or less.

7. The textile printing ink jet ink composition according to claim 1, comprising any one or more pH adjusters selected from acetic acid, citric acid, lactic acid, malonic acid, and succinic acid.

8. The textile printing ink jet ink composition according to claim 1, comprising a lactam-based compound.

9. The textile printing ink jet ink composition according to claim 8, wherein
the lactam-based compound includes 1-(2-hydroxyethyl)-2-pyrrolidone (HEP).

10. A recording method comprising:
ejecting the textile printing ink jet ink composition according to claim 1 from an ink jet head and attaching the textile printing ink jet ink composition to a fabric.
